(19) United States
(12) Patent Application Publication
(10) Pub. No.: US 2007/0257392 A1
(43) Pub. Date: Nov. 8, 2007

(54) Apparatus and Method for Manufacturing Concrete

(75) Inventor: Philip Etherton, Surrey (GB)

Correspondence Address: BROOKS KUSHMAN P.C., 1000 TOWN CENTER, TWENTY-SECOND FLOOR, SOUTHFIELD, MI, 48075, US

(73) Assignee: INNOVATIONS HOLDINGS (UK) LIMITED, Surrey (GB)

(21) Appl. No.: 11/572,107

(22) PCT Filed: Jul. 13, 2005
(86) PCT No.: PCT/GB05/02737

§ 371 Date: Jan. 14, 2007

(30) Foreign Application Priority Data
Jul. 13, 2004 (GB) 0415685.7

(51) Int. Cl. B28B 7/04

(52) U.S. Cl. 264/49

(57) ABSTRACT

Concrete making apparatus for mounting on a vehicle for manufacturing concrete on-site, the apparatus comprising a plurality of separate containers (203, 205, 207) for storage of components of the concrete; weighing means for determining weight of at least one of the components; a mixer (211) for mixing the components together and dispatching mixed concrete; and delivery means (209, 210) for dispensing components from their respective containers (203, 205, 207) and conveying components to the mixer. The rate of delivery of components by the delivery means (209, 210) is dependent on the weight of the at least one component determined by the weighing means and the particular supply of mixed concrete required from the mixer (211).

The invention relates to an apparatus and method for manufacturing concrete on-site. More particularly, but not exclusively, the invention relates to a concrete making vehicle for manufacturing concrete on-site.

Currently, there are two types of mixer equipment for manufacturing concrete. The first, more traditional type of mixer equipment is known as a batching plant, which supplies barrel or drum mixers. In this arrangement, the operator will select the required amount and slump of concrete for a particular application. The appropriate amounts of each component are then added to the mixing barrel and, after mixing, a batch of concrete is provided. An advantage of a batch mixer is that the mixer provides a high quality, reliable concrete mix, because the aggregate and cement are very accurately measured by weight prior to mixing. Many end users prefer the batch mixing process because of the guaranteed high quality mix it can provide.

On the other hand, a disadvantage of a batch mixer is that there is no opportunity to alter the concrete mix after the components have been added and the mixing has begun; if a different slump is required (for example at a different job-site or because a given job-site has different requirements from those expected) a whole new batch must be produced. A further disadvantage of a batch mixer is that the concrete may deteriorate in transit, especially with highly aerated concrete.

The second type of mixer equipment is known as a volumetric mixer. In this arrangement, the materials required for the concrete mix are transported to the site in separate hoppers on a vehicle. When the concrete is required, the separate components are steadily added to a mixer, also on board the vehicle, in the appropriate proportions to provide a steady continuous supply of the required concrete mix. The concrete mix can be supplied as and when required. There are several advantages of volumetric mixers. Firstly, if different mix designs are required at one or several different sites, the operator can vary the components of the concrete. This is normally done by altering the gate settings on the aggregate bin, while keeping the cement feed constant. Secondly, a suitable accelerator can be injected at the end of the mixing auger in order to rapidly set the concrete. A third advantage is that, since the constituents of the mix are transported to the site separately, the concrete is always fresh and does not deteriorate in transit.

On the other hand, a disadvantage of volumetric mixers currently available is that the quality and reliability of the concrete mix may not be very high, since the proportions of the components are dependent on the skill of the operator. For example, a gate on a particular component hopper may be set incorrectly, thereby resulting in an inappropriate mix for the particular application or all the component supplies may be set too high resulting in a supply rate which is too high for the particular application.

A further disadvantage is that the bulk densities of the components of the mix vary from one supply to the next. In order to allow for this, the component hoppers and their gates would need to be re-calibrated each load/pour, which would reduce the versatility of the volumetric mixer. Thus, despite the advantages of volumetric mixers, many users do not favour them as they have no guarantee of the quantity and quality of the concrete mix provided.

Batch mixing and volumetric mixing are two very different processes. The static batch mixing plants serve a different market from that of the volumetric machines. Because of their different advantages and disadvantages, the two types of concrete mixing tend to be used in very different applications: batching for high quality concrete for use in industrial applications and volumetric machines for the domestic market (garage drives, fence posts etc.).

It is an object of the invention to provide an apparatus and method for manufacturing concrete on-site, which substantially overcome or mitigate problems of known concrete mixing apparatus and methods.

According to the invention, there is provided concrete making apparatus for mounting on a vehicle, for manufacturing concrete on-site, the apparatus comprising:
a plurality of separate containers for storage of components of the concrete;
weighing means for determining weight of at least one of the components;
a mixer for mixing the components together and supplying mixed concrete; and
delivery means for dispensing components from their respective containers and conveying components to the mixer; wherein the rate of delivery of components by the delivery means is dependent on the weight of the at least one component determined by the weighing means and the particular supply of mixed concrete required from the mixer.

By providing weighing means for determining the weight of the components, along with delivery means for controlling the rate of delivery of components, the proportions of the components in the concrete mix by weight can be very accurately controlled. Thus, a high quality, reliable mix can be provided on-site.

Further, since the rate of delivery is dependent on the weight of the at least one component and the particular mix required, there is less chance of operator error.

The concrete making apparatus may further comprise a processor connected to the weighing means and the delivery means for controlling the rate of delivery of components. The processor is connected to the weighing means so that the amount by weight of each component provided for the mix may be monitored by the processor. The processor is also connected to the delivery means so that it can monitor the rate of delivery of components and, if necessary, adjust the rate of delivery.

The processor is preferably a programmable processor. If the processor is programmable, the required ratio by weight of components in the mix can be entered onto the processor which, in turn, can control the rate of delivery of components to ensure that the ratio is maintained. Thus, the proportions (by weight) of components in the mix are very accurate and the resulting mix is high quality and reliable. Preferably, the processor is programmable by an operator in accordance with the particular concrete mix required. The processor may be programmed before use or may be programmed on-site.

The processor may further comprise storage means for storing several sets of concrete mix data at once. In this way, an operator can simply select the required mix from the stored selection.

In a preferred embodiment, the delivery means comprises at least one conveyor for delivery of at least one dry component. Preferably, the speed of the conveyor is adjustable. If the concrete making apparatus includes a processor, the speed of the conveyor is preferably adjustable by the processor. Thus, the processor can monitor the conveyor and appropriately adjust the conveyor speed to adjust the delivery rate of one or more dry components. The dry components may include aggregate (sand and stone) and cement.

Similarly, in a preferred embodiment, the delivery means comprises at least one conduit for delivery of at least one fluid component. Preferably, the flow rate of fluid components through the at least one conduit is adjustable. Preferably, the apparatus further comprises at least one pump for conveying fluid component(s) along the at least one conduit. The flow rate of fluid components may be adjustable by adjusting the pump speed. Alternatively, the flow rate of fluid components may be adjustable by increasing or decreasing the flow via specially designed solenoids. If the concrete making apparatus includes a processor, the flow rate of the at least one fluid component through the at least one pipe is preferably adjustable by the processor.

Thus, the processor can appropriately adjust the flow rate to adjust the delivery rate of one or more components. This may be by adjusting the pump speed of the at least one pump which convey fluid component(s) along the at least one conduit. The fluid components may include water and liquid admixtures.

Preferably, the concrete making apparatus further comprises flow rate sensing means for determining the rate of delivery of fluid components. If the apparatus comprises a processor, preferably, the processor is connected to the flow rate sensing means.

Preferably, the processor is arranged to continuously control the rate of delivery of components as the mixed concrete is supplied. In this way, the processor can make continuous adjustments to the delivery rates in order to provide a highly accurate mix. Preferably, the weighing means is arranged to continuously determine the weight of the at least one component. Thus, the delivery rate can be continuously adjusted in response to the (changing) component weight(s).

The processor may be remotely operable. This may increase safety for an operator.

Preferably, the plurality of separate containers comprises at least one hopper for storing aggregate. Preferably, the hopper for storing aggregate comprises separate sections for stone and sand. Also, preferably, the plurality of separate containers comprises a tank for storing water. Further, the plurality of separate containers preferably comprises a container for cement.

In one particularly advantageous embodiment, the weighing means comprise load cells on which each container is mounted. In this way, the weight of each component provided for the mix may be determined when the components are stored in the containers. In known concrete mixing equipment, the storage containers are all mounted on one frame. In this embodiment each storage container is mounted separately on load cells, so that the weight of each component in the container may be determined.

In an alternative embodiment, the weighing means comprise load cells on which the delivery means is mounted. In that way, the weight of each component provided for the mix may be determined when the components are being delivered to the mixer.

In one embodiment, the mixer is an elongate tubular mixer and the mixed concrete is dispatched at the downstream end of the mixer. In that case, the mixer may include one or more supply means along its length for successive introduction of the components into the mixer.

In one particularly advantageous embodiment, the concrete making apparatus further comprises measuring means for determining the volume of at least one of the components. This means that the amount of a component used can be dependent on volume as well as on weight. Advantageously, the apparatus is arranged to be able to manufacture concrete without using the weighing means. This means the apparatus can be used in situations where using the weighing means is not possible, for example when the apparatus is positioned on an incline greater than 5%, in which case the load cells will not function correctly. In other words, in situations where it is not suitable to use the weighing system, the apparatus can manufacture concrete volumetrically instead.

According to the invention, there is also provided a concrete making vehicle comprising concrete making apparatus as hereinbefore described.

According to the invention, there is also provided a method for manufacturing concrete on-site, the method comprising the steps of:
providing a plurality of separate containers for storage of components of the concrete;
delivering components to a mixer by dispensing components from their respective containers and conveying components to the mixer;
either before or after the dispensing step, weighing at least one of the components;
mixing the components together in the mixer; and
dispatching mixed concrete, wherein the rate of delivery of components by the delivery means is dependent on the weight of the at least one component and the particular supply of mixed concrete required.

The rate of delivery is dependent on the weight of the at least one component and the particular supply of mixed concrete required so that the proportions by weight of the components in the mix may be accurately controlled and a high quality mix achieved.

Preferably, the steps of delivering, mixing and dispatching are carried out continuously to provide a continuous supply of mixed concrete. This is advantageous because an appropriate amount of high quality mixed concrete may be provided with minimal wastage and the mixed concrete provided is extremely fresh. In addition, preferably the step of weighing is carried out continuously so that delivery rate(s) can be continuously controlled.

In one embodiment of the invention, the rate of delivery of components is controlled by a processor. The processor may be a programmable processor. In this way, the processor may appropriately control the rate of delivery of components in dependence upon the weight of the at least one component and the particular mixed concrete required.

If the processor is programmable, the required ratio by weight of components in the mix can be entered into the processor which, in turn, can control the rate of delivery of components to ensure that the desired ratio is maintained. Thus, the proportions of components in the mix are very accurate and the resulting mix is high quality and reliable.

The method preferably further comprises the step of programming the processor in accordance with the particular concrete mix required. This may be done before use or may be done on-site by an operator. The processor may, in addition, be able to store several sets of mix data at once so that the operator can simply select the required mix from the stored selection.

The plurality of separate containers preferably comprises at least one hopper for storing aggregate and/or a tank for storing water and/or a container for cement.

The step of weighing the components may be carried out before or after the dispensing step. In the former case, the step of weighing the components may be carried out by load cells on which the container is mounted.

Preferably, the method further comprises continuously monitoring the rate of delivery of the components.

According to the invention, there is also provided concrete making equipment for carrying out a method as hereinbefore described.

According to the invention, there is provided a concrete making vehicle for carrying out a method as hereinbefore described.

It will be appreciated that any feature described above in respect of one aspect of the invention may also be applicable to another aspect of the invention.

An exemplary embodiment of the invention will now be described with reference to the accompanying drawings, of which:

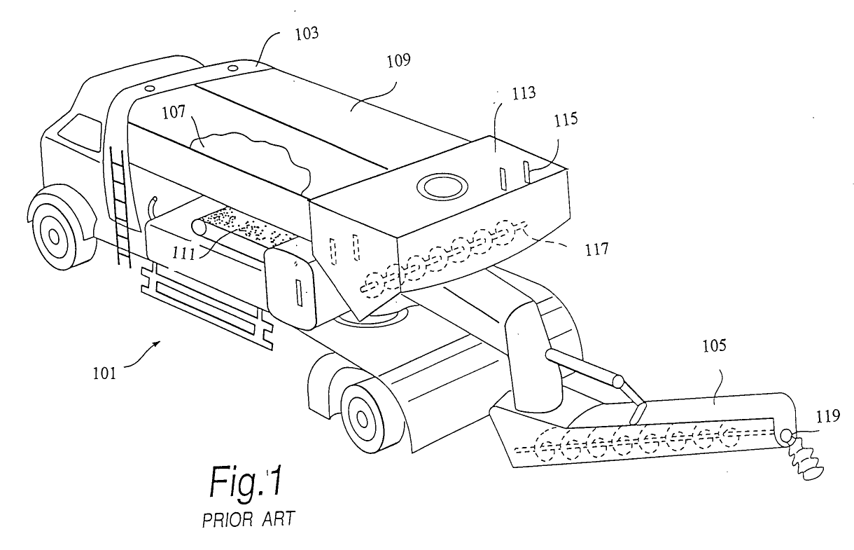

FIG. 1 is a schematic perspective view of a prior art concrete mixing vehicle;

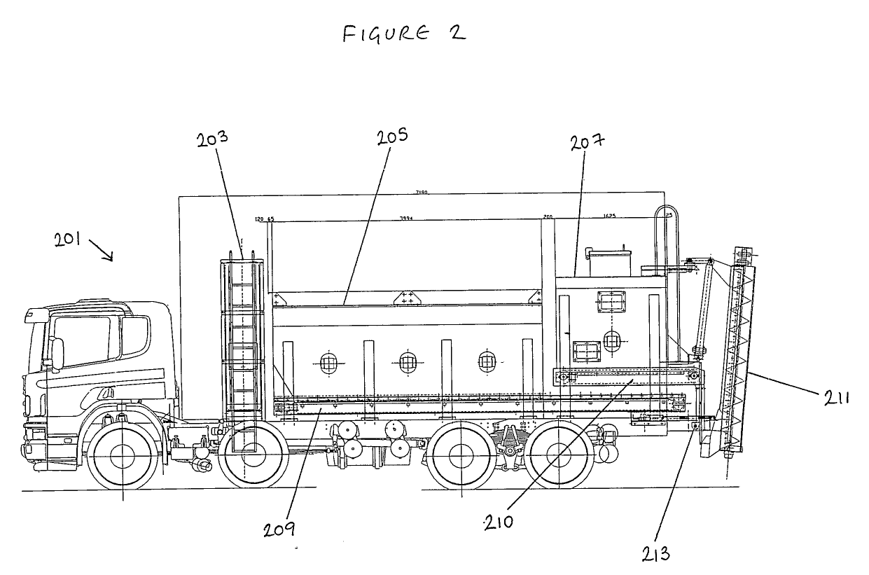

FIG. 2 is a side elevation view of a concrete mixing vehicle according to the invention; and

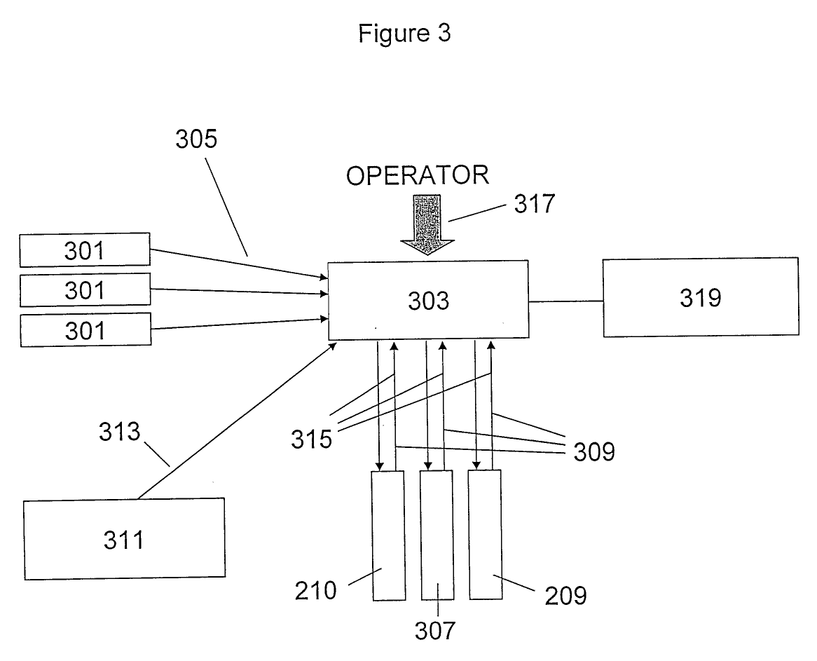

FIG. 3 is a block diagram showing operation of the concrete mixing vehicle according to the invention.

FIG. 1 shows a concrete mixing vehicle according to the prior art. In the vehicle 101, the water is stored in a water tank 103 mounted at the front of the vehicle and is pumped hydraulically to a mixer 105 located at the rear of the vehicle. The aggregate 107 is stored in open-topped bins 109 located behind the water tank 103. A conveyor belt 111, mounted directly beneath the open bottoms of the bins 109, transports the aggregate to the mixer 105. The cement is stored in a watertight bin 113 positioned at the rear of the vehicle 101. The bin 113 is provided with vibrators 115 and internal mixing/discharge means 117 that deliver the cement to the conveyor belt 111 below. Independent storage systems (not shown) for supplying liquid admixtures such as, for example, accelerators, retarders and foaming agents, are also provided. It should be noted that the containers for the various components are mounted on a common frame which is then attached to the vehicle.

During operation, an operator appropriately adjusts discharge means on the bins 109, the water tank 103, the bin 113, and any other storage means for other mix components, in accordance with the particular concrete mix required and particular supply rate required. The dry components fall onto the conveyor belt 111 and are transported to the rear of the vehicle, the liquid components are pumped to the rear of the vehicle, all the components are combined and mixed inside the elongate mixer 105 and mixed concrete is discharged from the delivery end 119 of the mixer 105.

FIG. 2 is a side elevation view of a concrete mixing vehicle according to the invention. In the vehicle 201, the water is stored in a water tank 203 mounted at the front of the vehicle and the aggregate is stored in an open-topped bin 205 at the centre of the vehicle. In this embodiment, bin 205 is divided into two sections (not shown in FIG. 2), one section 205a for sand, the other section 205b for stone. Alternatively, the bin 205 may comprise only one section containing pre-mixed aggregate. The cement is stored in a watertight bin 207 positioned at the rear of the vehicle. Conveyor belt 209 is positioned beneath bin 205 for delivering the aggregate (sand and stone mixture) to the mixer 211 at the rear of the vehicle. Conveyor belt 210 is positioned beneath bin 207 for delivering the cement to the mixer 211 at the rear of the vehicle. Water from tank 203 is pumped to the mixer hydraulically by pumps (not shown). Other liquid components are also pumped to the mixer hydraulically. Flow meters (not shown) are provided in the water and other liquid component supplies to monitor the rate of supply of water/liquid. The containers for the various components are all mounted independently on the vehicle. Mixer 211 is shown in its upright position for storage; in use, it pivots around joint 213 to a more horizontal position for delivery of mixed concrete.

In the embodiment shown in FIG. 2, aggregate bin 205 and cement bin 207 are mounted on load cells (not shown) for monitoring the weight of aggregate/cement in the bin. Conveyor belt 209 forms the bed of the aggregate bin and there are separate gates (not shown) on the sand section 205a and on the stone section 205b of the aggregate bin 205. As the conveyor belt 209 removes the sand and stone from the bin, the settings on the gates determine the amount of sand and stone exiting the bin 205 on the conveyor belt 209. Thus the settings on the gates control the ratio of sand:stone and the conveyor belt 209 speed controls the rate of supply of aggregate. Similarly, conveyor belt 210 is linked to the bin 207 so that the overall supply rate of cement can be controlled by varying the conveyor belt 210 speed. The conveyor belts 210 and 209 are controlled by a processor (not shown) which is programmable according to the ratio by weight of components required in the concrete mix.

In an alternative embodiment, the weight of each dry component in the mix is determined in a different way: by mounting the conveyor belts 209 and 210 on load cells. In that way, the individual component containers need not be separately mounted but the weights of the components may be monitored as they pass along the conveyor belts.

Independent storage systems (not shown) for supplying liquid admixtures such as, for example, accelerators, retarders and foaming agents, may also be provided.

Before or during operation, the operator sets the gates on the sand and stone supplies appropriately in accordance with the ratio of sand:stone required in the aggregate. In addition, either before or during operation, the required concrete mix is programmed into the processor.

During operation, the weights of the components are fed into the processor and the processor adjusts the speeds of conveyor belts 209 and 210 in accordance with the aggregate gate settings and in accordance with the weight ratio of aggregate:cement required. In addition, the flow rates of the liquid components are fed into the processor and the processor adjusts the pump speeds (or solenoids) in accordance with the weight ratio of aggregate:liquid components required. All the components are mixed in the mixer and fresh mixed concrete is dispatched from the delivery end of the mixer 211.

If the ratio of aggregate:cement or aggregate:liquid components needs to be altered, the operator can simply program this into the processor and the processor will adjust the conveyor belt 209 speed and/or the conveyor belt 210 speed and/or the liquid component pump speeds accordingly. The operator does not need to take any further action.

Similarly, if the supply rate of the mixed concrete needs to be adjusted, the operator can increase or decrease the conveyor belt 209 speed appropriately, the load cells on the bin 205 will detect the change (because more or less sand/stone will pass through the gates per unit time) and the processor will make the necessary adjustments to the cement and liquid output rates to ensure that all components of the programmed mix design are kept to the correct ratio. (It will be appreciated that an alternative way to alter the aggregate supply rate is to change both gate settings whilst keeping the conveyor speed constant. This involves more operator input, however, and there is more opportunity for error and accidents, so this is not often done in practice.)

Thus, because operator input is kept to a minimum, the majority of the adjustments being made automatically, the time taken for adjusting the mix is reduced and the likelihood of operator error is reduced.

FIG. 3 is a block diagram showing operation of the concrete mixing vehicle. The load cells 301 on each component container are connected to a processor 303. The weight of component in each container is inputted (arrow 305) to the processor 303. The processor 303 is also connected to the conveyor belt 209, to the conveyor belt 210 and to the liquid flow meters/pumps 307. In that way, the rate of dispense of cement, liquid components and aggregate may be continuously monitored (arrows 309) by the processor. The processor 303 processes the data from the load cells 301, the conveyor belts 210 and 209 and the liquid flow meters/pumps 307 and appropriately controls (arrows 315) the speeds of the conveyor belts 210 and 209 and the pumps 307 in order to maintain the required ratio of components in the concrete mix. Data on the required concrete mix is programmed into the processor 303 by an operator (input 317). In addition, a selection of concrete mix data may be stored in storage means 319 for access by the processor so that the operator does not need to input new data each time but can simply select from the stored concrete mix data.

In the case where the conveyor belt (rather than each component container) is mounted on load cells, operation of the vehicle is similar, the only difference being that the weight of the components is determined once the components have been dispensed from their containers and are being delivered to the mixer.

1. Concrete making apparatus for mounting on a vehicle for manufacturing concrete on-site, the apparatus comprising: a plurality of separate containers for storage of components of the concrete; weighing means for determining the weight of at least one of the components; a mixer for mixing the components together and dispatching mixed concrete; and delivery means for dispensing components by the delivery means is dependent on the weight of the at least one component determined by the weighing means and the particular supply of mixed concrete required from the mixer; and wherein the weighing means comprise load cells on which each container is separately mounted.

2. Concrete making apparatus according to claim 1 further comprising a processor connected to the weighing means and the delivery means for controlling the rate of delivery of components.

3. Concrete making apparatus according to claim 2 wherein the processor is a programmable processor.

4. Concrete making apparatus according to claim 3 wherein the processor is programmable by an operator in accordance with the particular concrete mix required.

5. Concrete making apparatus according to claim 1 wherein the delivery means comprises at least one conveyor for delivery of at least one dry component.

6. Concrete making apparatus according to claim 5 wherein the speed of the conveyor is adjustable.

7. Concrete making apparatus according to claim 6, when dependent on claim 2, wherein the speed of the conveyor is adjustable by the processor.

8. Concrete making apparatus according to claim 1 wherein the delivery means comprises at least one conduit for delivery of at least one fluid component.

9. Concrete making apparatus according to claim 8 wherein flow rate of the at least one fluid component through the at least one conduit is adjustable.

10. Concrete making apparatus according to claim 9, when dependent on claim 2, wherein the flow rate of the at least one fluid component along the at least one conduit is adjustable by the processor.

11. Concrete making apparatus according to claim 1 further comprising flow rate sensing means for determining the rate of delivery of fluid components.

12. Concrete making apparatus according to claim 11 when dependent on claim 2, wherein the processor is connected to the flow sensing means.

13. Concrete making apparatus according to claim 2 wherein the processor is arranged to continuously control the rate of delivery of components as the mixed concrete is supplied.

14. Concrete making apparatus according to claim 1 wherein the plurality of separate containers comprise a hopper for storing aggregate.

15. Concrete making apparatus according to claim 14 wherein the hopper for storing aggregate comprises separate sections for stone and sand.

16. Concrete making apparatus according to claim 1 wherein the plurality of separate containers comprise a container for cement.

17. Concrete making apparatus according to claim 1 wherein the mixer is an elongate tubular mixer and the mixed concrete is dispatched at the downstream end of the mixer.

18. Concrete making apparatus according to claim 17 wherein the mixer includes one or more supply means along its length for successive introduction of the components into the mixer.

19. Concrete making apparatus according to claim 1 further comprising measuring means for determining the volume of at least one of the components.

20. Concrete making apparatus according to claim 19 wherein the apparatus is arranged to be able to manufacture concrete without using the weighing means.

21. (canceled)

22. A concrete making vehicle comprising concrete making equipment according to claim 1.

23. A method for manufacturing concrete on-site, the method comprising the steps of:
providing a plurality of separate containers for storage of components of the concrete;
delivering components to a mixer by dispensing components from their respective containers and conveying components to the mixer; either before or after the dispensing step, weighing at least one of the components;
mixing the components together in the mixer; and
dispatching mixed concrete, wherein the rate of delivery of components by the delivery means is dependent on the weight of the at least one component and the particular supply of mixed concrete required; and wherein the step of weighing the components is by load cells on which each container is separately mounted.

24. A method according to claim 23 wherein the steps of delivering, mixing and dispatching are carried out continuously to provide a continuous supply of mixed concrete.

25. A method according to claim 23 wherein the rate of delivery of components is controlled by a processor.

26. A method according to claim 25 wherein the processor is a programmable processor.

27. A method according to claim 26 further comprising the step of programming the processor in accordance with the particular concrete mix required.

28. A method according to claim 23 further comprising continuously monitoring the rate of delivery of the components.

29. Concrete making equipment for carrying out a method according to claim 23.

30. A concrete making vehicle for carrying out a method according to claim 23.
